(19) United States
(12) Patent Application Publication
(10) Pub. No.: US 2001/0016255 A1
(43) Pub. Date: Aug. 23, 2001

(54) Foamed thermoplastic resin article

(76) Inventors: Nobuhiro Usui, Osaka (JP); Takeo Kitayama, Osaka (JP)

Correspondence Address: PILLSBURY WINTHROP LLP, 1600 TYSONS BOULEVARD, MCLEAN, VA, 22102, US

(21) Appl. No.: 09/778,036

(22) Filed: Feb. 7, 2001

(30) Foreign Application Priority Data
Feb. 18, 2000 (JP) 2000-041127

(51) Int. Cl. B32B 3/26

(52) U.S. Cl. 428/318.6; 428/319.9; 428/318.8; 428/213

(57) ABSTRACT

The present invention provides a foamed thermoplastic resin article having light weight and high stiffness suitable for interior members for automobile, as well as having soft feel of a skin layer, which is formed by integrally laminating a skin material and a thermoplastic resin foamed base material while forming the same, wherein the thermoplastic resin foamed base material is composed of a foamed core layer, a skin layer of the skin material side and a skin layer of the backside, and when thickness of the skin layer of the skin material side is defined as A, and thickness of the skin layer of the backside is defined as B, the A and B satisfy the relationship of A<B.

### BACKGROUND OF THE INVENTION

1. Field of the Invention

The present invention relates to a foamed thermoplastic resin article, and more specifically to a foamed thermoplastic resin article having light weight and high stiffness suitable for interior members for automobile, as well as having soft feel of a skin layer.

2. Description of the Prior Art

Thermoplastic resin articles formed by injection-molding a thermoplastic resin and laminating a skin material on the molded resin have been previously used in the field of interior members for automobile, however, these articles have high density and thus large weight, so that weight reduction of these articles has been requested especially in the field of interior materials for automobile.

For achieving weight reduction as interior materials for automobile parts by using a thermoplastic resin and forming the inner layer thereof with a foamed resin, such a method has been known that a skin material is placed between a pair of female and male mold halves; an interval between the mold halves (cavity clearance) is set at a predetermined value; a polypropylene resin composition containing an foaming agent is introduced between the skin material and the female mold half and simultaneously the mold halves are closed, thereby forming the resin into a predetermined shape and integrating the resin with the skin material; the mold halves are opened to provide a predetermined space thereby causing a core portion of the resin to foam; and then the resultant article is cooled (Japanese Unexamined Patent Publication JP-A 6-344362).

However, in the case of the article of which skin material and thermoplastic resin foamed base material are laminated and integrated with each other as disclosed in the above Japanese Unexamined Patent Publication JP-A 6-344362, though it was possible to achieve weight reduction, it was impossible to satisfy both requirements of soft feel of the skin material layer and increased stiffness owned by the article at the same time.

In other words, in such an article previously known as one disclosed in the above patent publication, skin layers (unfoamed solidified layers) having the same thickness are formed on both the skin material side and backside of the thermoplastic resin foamed base material, and the stiffness and weight reduction are balanced by mainly adjusting the thickness of these skin layers.

For this reason, a problem arose that when attempt was made to obtain an article of high stiffness, the thickness of the skin layers on both sides became large so that soft feel of the skin material layer of the article was insufficient, whereas when attempt was made to obtain sufficient soft feel of the skin material layer, the thickness of the skin layers on both surfaces became small to deteriorate the stiffness owned by the article.

### SUMMARY OF THE INVENTION

The present invention is directed to solve the above-mentioned problem, and to provide an article having light weight and high stiffness, as well as soft feel of a skin material layer, which is formed by integrating the skin material and the thermoplastic resin foamed base material.

The present invention provides a foamed thermoplastic resin article formed by integrally laminating a skin material and a thermoplastic resin foamed base material while forming the same,

wherein the thermoplastic resin foamed base material is composed of a foamed core layer, a skin layer of the skin material side and a skin layer of the backside, and when thickness of the skin layer of the skin material side is defined as A, and thickness of the skin layer of the backside is defined as B, the A and B satisfy the relationship of A<B.

Skin layers in the thermoplastic resin article of the present invention mean unfoamed layers formed on both surfaces in the thickness direction of the foamed core layer, and the fact that thickness A of the skin layer of the skin material side and thickness B of the skin layer of the backside satisfy the relationship of A<B means that at the same position in the thickness direction of the article, the relationship between the thickness A of the skin layer of the skin material side and the thickness B of the skin layer of the backside is A<B. In the article of the present invention, it is sufficient that the relationship A<B is satisfied in the part where the skin material and the thermoplastic resin foamed base material are integrated with each other, and for example, in the case of an article having a non-product portion where the skin material is not laminated on the thermoplastic resin foamed base material or in the case of an article in which the skin material is partly laminated on the thermoplastic resin foamed base material and integrated therewith, the relationship A<B does not need to be satisfied in the part of the article where the skin material is not laminated on the thermoplastic resin foamed base material.

With the configuration that the foamed core layer, the skin layer of the skin material side, and the skin layer of the backside are provided and that thickness A of the skin layer of the skin material side on which the skin material is laminated and thickness B of the skin layer of the backside satisfy the relationship A<B, it is possible to obtain a foamed thermoplastic resin article of which feel of the surface material layer is soft while satisfying the requirements of light weight and high stiffness. It is preferred that expansion ratio of the foamed core layer is not less than 2 times, and specifically not less than 3 times from the view point of weight reduction of the article.

In the above-mentioned foamed thermoplastic resin article, it is preferable that the skin material has a cushion layer having a compressive modulus of elasticity of not more than 0.3 MPa on the backside, i.e., on the lamination side of the thermoplastic resin foamed base material.

Since the cushion layer is formed between the skin material and the thermoplastic resin foamed base material, it is possible to obtain a foamed thermoplastic having further improved soft feel of the skin material layer.

The above-mentioned compressive modulus of elasticity of the cushion layer is the initial modulus when the constituent material of the cushion layer is compressed at a compression speed of 1 mm/min by a disc of 50 mm in diameter.

In the thermoplastic resin article of the present invention, it is more preferable that the relationship between the thickness A of the skin layer of the skin material side and the thickness B of the skin layer of the backside is A≦0.8B, which enables formation of the foamed thermoplastic resin article having soft feel of the skin material layer with higher reliability.

Furthermore, in order to maintain the soft feel of the skin material layer, the thickness A of the skin layer of the skin side is preferably not more than 1 mm regardless of thickness of the foamed thermoplastic resin article of the present invention.

Preferably, the thermoplastic resin forming the foamed thermoplastic resin article of the present invention is polyolefine-based resin, particularly polypropylene-based resin, which makes it possible to obtain a foamed thermoplastic resin article which is low in cost, and high in strength and stiffness.

As the polypropylene-based resin, polypropylene-based resins of which melt flow rate (MFR) value is not less than 15 (g/10 min), more preferably not less than 25 (g/10 min) are particularly used.

By using polypropylene-based resins having MFR of the above range, it is possible to prevent foams from being collapsed and form the foamed core layer reliably, with the result that it is possible to obtain a foamed thermoplastic article of light weight and high stiffness, and having soft feel of the skin material layer as a result of satisfying the above described A<B, more preferably A≦0.8B.

The foamed thermoplastic resin article of the present invention may be preferably used in the field of interior materials for automobile, and to be more specific, an instrument panel, sheet back, partition board, console box, door trim and the like are exemplified.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step.

### BRIEF DESCRIPTION OF THE DRAWINGS

FIG. 1 is a view showing a partial cross-sectional shape of an example of the panel-shaped foamed thermoplastic resin article of the present invention; and

FIG. 2 is a view showing an example of production process of the panel-shaped foamed thermoplastic resin article of the present invention.

### DESCRIPTION OF THE PREFERRED EMBODIMENT

Embodiments of the present invention will be described with reference to the drawings.

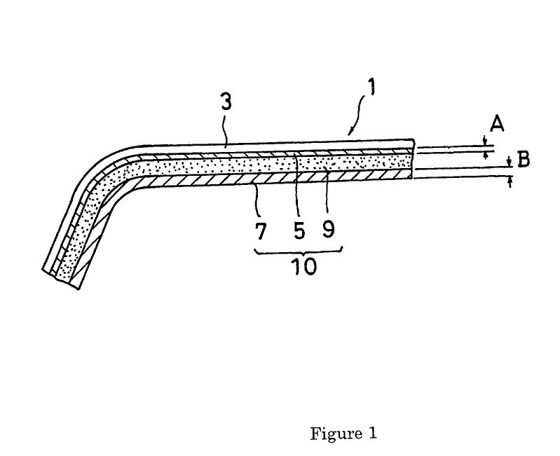

FIG. 1 shows a partial cross-sectional shape of an example of the panel-shaped foamed thermoplastic resin article (hereinafter, simply referred to as a panel).

A panel 1 is formed by laminating a skin material 3 and a thermoplastic resin foamed base material 10, and the thermoplastic resin foamed base material 10 is composed of a skin layer of the skin material side 5, a skin layer of the backside 7 and a foamed core layer 9. When thickness of the skin layer of the skin material side 5 is defined as A and thickness of the skin layer of the back side 7 is defined as B, the relationship A<B is satisfied.

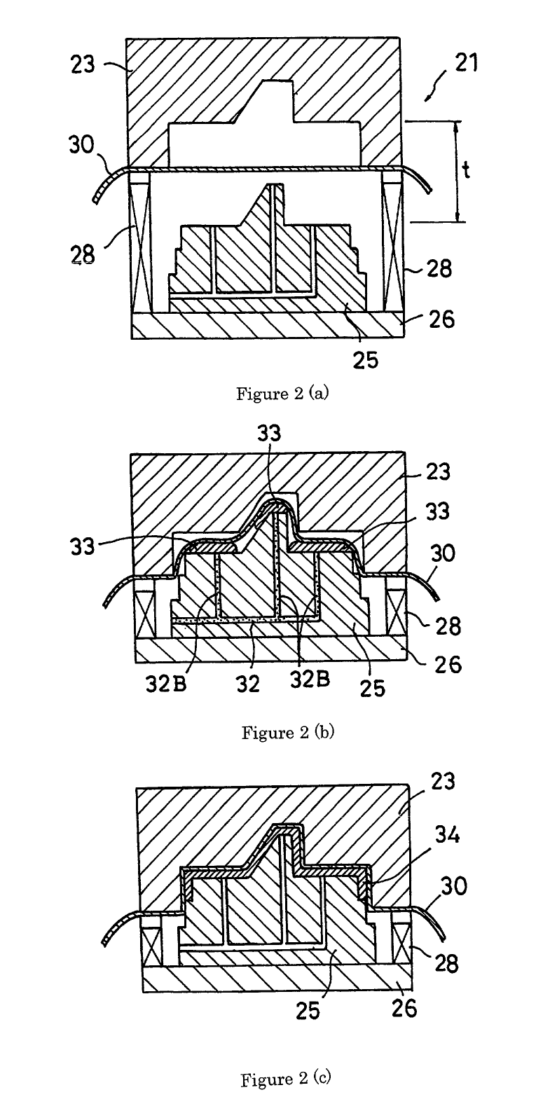

The shape of the panel of the present invention is not particularly limited to two-dimensional shape, but may be a curved surface in accordance with a particular use and object, or may be a three-dimensional shape such as interior materials for automobile. In the following, an example for manufacturing a panel having a three-dimensional shape formed by laminating a skin material layer on the surface will be described with reference to FIG. 2. For manufacturing the panel, a pair of female and male mold halves composed of a female mold half 23 and a male mold half 25 fixed on a base 26, of which cavity clearance (t) is arbitrarily set are used.

In forming the foamed thermoplastic resin article of the present invention, temperature setting of each of the female and male mold halves is important, and the temperature of one of the female and male mold halves which will be the skin material side is set higher than the temperature of other of the female and male mold halves which will be the backside.

Preferably, the temperature of the mold half which will be the skin material side is not more than 80° C. from the view point of reduction of cooling time, and the temperature of the mold half on the backside (opposite to the skin material side) is preferably more than 10° C., more preferably more than 20° C. lower than the temperature of the mold half of the skin material.

The skin material 30 is held by a damper 28 with respect to the end surface of the female mold half 23 (See FIG. 2(a)). The skin material 30 is held by the damper 28 so that when the skin material 30 is drawn into the recess portion of the mold half for forming, it is slidable.

Next, at least one of the female mold half 23 and the male mold half 25 is moved to create a clearance for starting resin supply. While the clearance for starting resin supply is appropriately set, if the clearance is too wide, expansion of foams will rapidly occur to result in the situation that formation of foams is insufficient because the foaming agent becomes flat.

The process shown in FIG. 2(b) is a process for introducing a molten thermoplastic resin 33 containing an foaming agent through a resin supply path 32. While three branch paths 32B of the resin supply path 32 are formed in this example, the number of branch path 32B is not limited to three, but arbitrarily set according to the shape and size of the article.

After introducing a predetermined amount of the molten thermoplastic resin 33 containing an foaming agent, the cavity clearance of the mold halves is compressed to a predetermined thickness of the article or less, and under this condition, the surface layer of the resin is cooled to form a skin layer of the resin. By this compressing process, the skin material and the resin layer are adhered with each other. While the cooling time for forming the skin layer is appropriately set in consideration of thickness of the article, temperature of the mold half and the like, when taking practically applicable conditions for reducing the forming time and the like into consideration, about 1 to 30 seconds is preferred.

Next, the mold halves are opened so that the cavity clearance becomes a predetermined thickness of the article, the resin between the skin layers is allowed to expand to form the foamed core layer, whereby a panel-like foamed thermoplastic resin article which is a final product is obtained.

With respect to the forming, it is preferable that compression speed of the cavity clearance of the mold halves is 1 to 50 mm/sec, and compression is accomplished by causing the female and male mold halves to move in relation to each other. As for the pair of female and male mold halves, one of the mold halves may be moved, and both of the mold halves may be moved as necessary. Furthermore, it is preferable that introducing pressure of the molten thermoplastic resin is 0.5 to 50 MPa.

As the thermoplastic resin used in the present invention, resins that have been previously used for interior members for automobile may be used without limitation, and to be more specific, for example, polyolefine-based resins such as polypropylene-based resins and polyethylene-based resins, acryl resins such as polystyrene-based resins and poly(methylmethacrylate) resin, polyamide resins such as ABS and nylon-6, polyester resin, polycarbonate resin, polyphenylene ether resins and the like are exemplified. Among these resins, polypropylene-based resins are preferable from the view points of the formability, cost, and mechanical strength, and particularly polypropylene-based resins having a melt flow rate (MFR) value of not less than 15 (g/10 min) are more preferred.

As the foaming agent to be added to the thermoplastic resin, known foaming agents used in producing foamed materials of thermoplastic resin may be used. To be more specific, for example, inorganic foaming agents such as sodium hydrogencarbonate, ammonium hydrogencarbonate, ammonium carbonate and the like, and organic foaming agents such as nitroso compounds such as N,N′-dinitrosopentamethylenetetramine, azo compounds such as azodicarbonamide and azobisisobutyronitrile, sulfonyl hydrazides such as benzenesulfonylhydrazide, toluenesulfonylhydrazide, diphenylsulfone-3,3′-disulfonylhydrazide, p-toluenesulfonylsemicarbazide and the like are exemplified. Salicylic acid, urea and an foaming auxiliary containing the same may be added as necessary.

The kind of foaming agent may be selected by taking the melting temperature of the thermoplastic resin to be used and the objective expansion ratio and the like into consideration. Furthermore, the amount to be added is adjusted in consideration of the strength, density and the like of the objective article, and is generally 0.1 to 5 parts by weight with respect to 100 parts by weight of thermoplastic resin to be used.

Furthermore, besides the above foaming agent, it may be also possible to produce a foamed material of the thermoplastic resin by directly introducing liquid or gas carbon dioxide and/or nitrogen into the molten resin by pressuring.

As the skin material of the foamed thermoplastic resin article of the present invention, known skin materials may be used. To be more specific, for example, woven fabric, nonwoven fabric, knitted fabric, film and sheet formed of a thermoplastic resin or thermoplastic elastomer and the like are exemplified. In addition, also composite skin materials in which unfoamed sheets of polyurethane, rubber, thermoplastic elastomer and the like or foamed sheets are laminated on the above-mentioned skin materials may be exemplified.

As the material forming the cushion layer, for example, polyurethane foam, EVA foam, PP foam, PE foam and the like are exemplified, and polyurethane foam is most preferable because it can easily form a material having small compression set and a compression modulus of not more than 0.3 MPa. Furthermore, as the protection layer of the cushion layer, for example, woven fabric, nonwoven fabric, knitted fabric, sheets or films of thermoplastic resin or thermoplastic elastomer are exemplified, and the cushion layer may be backed by the protection layer.

### EXAMPLES

The present invention will be described more specifically by the following example. Forming was conducted by mounting a pair of female and male mold halves shown in FIG. 2 to a presser having a mold clamping force of 500 tons.

As the skin material, a skin material of triple-layered structure including a 0.5-mm-thick sheet made of olefine-based thermoplastic elastomer, a 4-mm-thick polyurethane foamed layer having a compression modulus of 0.2 MPa laminated on the 0.5-mm-thick sheet, and nonwoven fabric of 0.2 mm in thickness and 50 g/m² in METSUKE as a backing layer was used.

Furthermore, the foamable thermoplastic resin which is to become a thermoplastic resin foamed base material was prepared by melting a mixture of 100 parts of polypropylene (Sumitomo Noblen AZ564, Sumitomo Chemical Co., Ltd.: melt flow rate (MFR) 30 g/10 min.) and 3 parts by weight of inorganic foaming master batch (Cellmic MB3072 manufactured by Sankyo Kasei Kabushiki Kaisya) by heating at 200° C.

The forming process was as follows:

(1) The skin material (30) was placed between the female mold half (23) set at a temperature of 60° C. and the male mold half (25) set at a temperature of 30° C.; the female mold half (25) was moved to stop the press when the cavity clearance (t) of the mold halves becomes 15 mm; the heated molten expandable thermoplastic resin was supplied between the skin material (30) and the male mold half (25) from the resin supply path (32) provided in the male mold half (25); the mold halves were clamped at a compression speed of 10 mm/sec to form the skin material (30) and the expandable thermoplastic resin (33) of the molten state which is to become the thermoplastic resin foamed base material by pressure, while integrating them by lamination; the skin layer was formed on the surface of the resin. The condition of formation by pressure was pressurizing for 2 seconds at a surface pressure of 5 MPa, and the cavity clearance (t) at the time of pressurizing was 2.5 mm.

(2) Directly after the press-article, the female mold half (23) was moved 1.5 mm in the direction of opening the mold halves, thereby allowing the foamable thermoplastic resin in the molten state which had not been cooled and solidified to foam, and cooling was continued under the same condition for 50 seconds.

(3) After cooling, the thickness of the thermoplastic resin foamed base material in the taken out foamed thermoplastic resin article was 3.3 mm, the thickness of the skin layer on the skin material side in the thermoplastic resin foamed base material was 0.2 mm, the thickness of the skin layer on the backside (opposite to the skin material side) was 1 mm, the thickness of the foamed core layer was 2.1 mm, and the expansion ratio thereof was about two times. The foamed thermoplastic resin article was a laminate with an integrated skin, excellent in soft feel of the skin material layer, and also excellent in stiffness as an article.

What is claimed is:

1. A foamed thermoplastic resin article formed by integrally laminating a skin material and a thermoplastic resin foamed base material while forming the same,
wherein the thermoplastic resin foamed base material is composed of a foamed core layer, a skin layer of the skin material side and a skin layer of the backside, and when thickness of the skin layer of the skin material side is defined as A, and thickness of the skin layer of the backside is defined as B, the A and B satisfy the relationship of A<B.

2. The foamed thermoplastic resin article according to claim 1, wherein the skin material has a cushion layer having a compressive modulus of elasticity of not more than 0.3 MPa on the backside.

3. The foamed thermoplastic resin article according to claim 1, wherein the relationship between the thickness A of the skin layer of the skin material side and the thickness B of the skin layer of the backside is A≦0.8B.

4. The foamed thermoplastic resin article according to claim 1, wherein the thickness A of the skin layer of the skin side is not more than 1 mm.

5. The foamed thermoplastic resin article according to any one of claims 1 to 4, wherein thermoplastic resin is a polyolefine-based resin.

6. The foamed thermoplastic resin article according to any one of claims 1 to 4, wherein the thermoplastic resin is a polypropylene-based resin having a melt flow rate (MFR) value of not less than 15 (g/10 min).
